(19) United States
(12) Patent Application Publication
(10) Pub. No.: US 2018/0239121 A1
(43) Pub. Date: Aug. 23, 2018

(54) ELECTROMAGNETIC AND SOLAR ENERGY CONCENTRATOR

(71) Applicant: André Luiz ESTEVES PALMEIRA, Rio de Janeiro (BR)

(72) Inventor: André Luiz ESTEVES PALMEIRA, Rio de Janeiro (BR)

(21) Appl. No.: 15/537,651

(22) PCT Filed: Dec. 18, 2015
(86) PCT No.: PCT/BR2015/000193

§ 371 Date: Nov. 1, 2017

(30) Foreign Application Priority Data
Dec. 19, 2014 (BR) BR2020140320348

(51) Int. Cl. G02B 19/00; G02B 27/30; F24S 23/30

(52) U.S. Cl. CPC G02B 19/0009; F24S 23/30; G02B 27/30

(57) ABSTRACT

A solar and electromagnetic energy concentrator has lenses or lens sections having a circular circumference of different diameters which are determined by the diameter of the focal point produced by the previous lens, lenses or lens section on which each lens is superimposed.

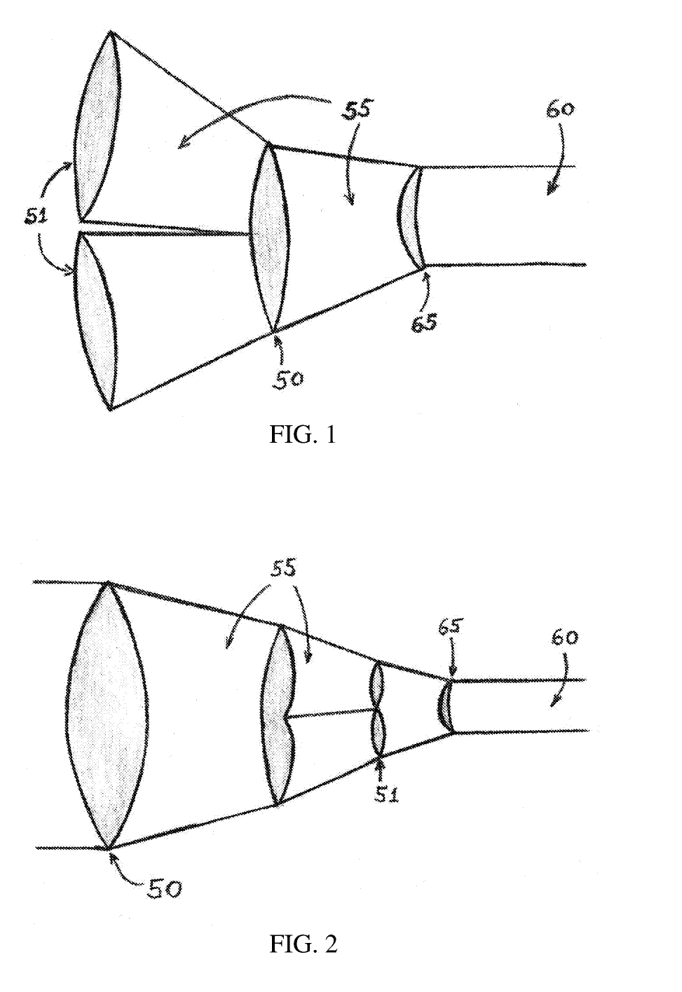

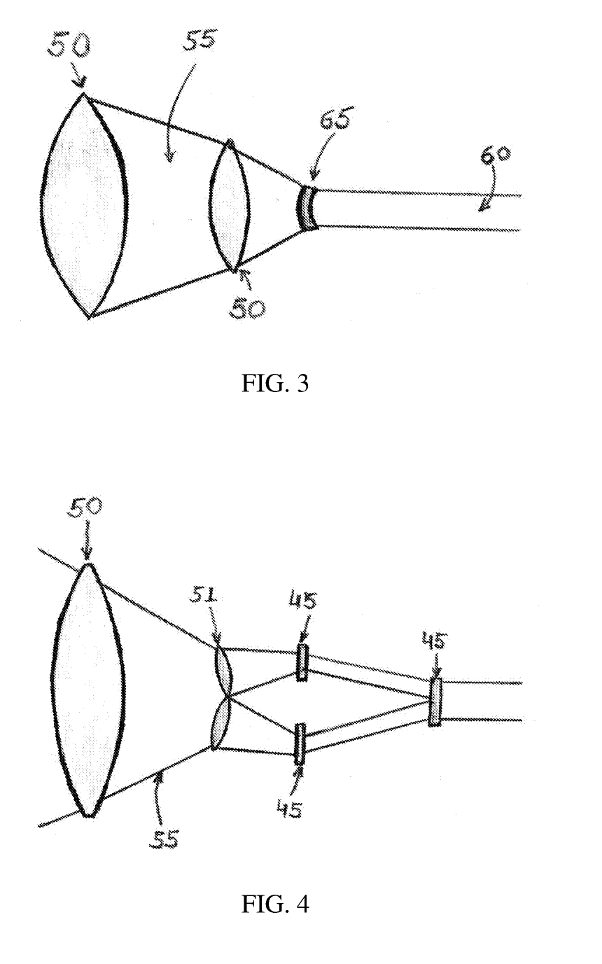

### TECHNICAL FIELD

The present utility model refers to a solar and electromagnetic energy concentrator. More specifically, the utility model refers to an electromagnetic energy concentrator of the Sun or one or more natural and/or natural sources of electromagnetic radiation isolated or combined with other natural and/or artificial electromagnetic sources.

### BACKGROUND

Concentrators have as their essential function to obtain the maximum amount of energy possible by refracting by concentrating the radiation(s) to which they are intended.

It is known that each wavelength of radiation needs a specific material to refract it. Thus, gamma radiation is only refracted by silicon, for example, which fulfills, through alignment of the atoms and/or shield shape, the magnifying and/or directing lens function. Therefore, since the lenses are made with different physicochemical compositions, the raw material of the lens should be that necessary to refract the radiation(s) for which it is intended and to withstand the conditions imposed by it.

There is a need in the prior art for concentrators which apply this principle to obtain maximum amount of energy efficiently and at a low cost.

It is necessary that the lenses exposed, for example, at high temperatures, be made of quartz glass, quartz crystal and/or other material necessary for refracting, concentrating and/or directing the radiation and withstanding high temperatures.

### UTILITY MODEL DESCRIPTION

With reference to the accompanying FIGURES, the solar and electromagnetic energy concentrator according to the present utility model has a preferred constructive option with the magnifying and/or directing lenses sized by and positioned at the focal point(s) of the preceding or next lens(es).

In order to have a reduced production cost, the concentrator of the present utility model presents, in a preferred constructive option, the magnifying and/or directing lenses subsequent to the first lens having the same sizes as the focal point(s) produced by the preceding lens(es), or sizes close to it.

The concentrator is composed of overlapping sections of one or more lenses or adjacent shields positioned at the point or focal points produced by the preceding lens(es) section.

The concentrator shows the first lens(es) of the set as large as possible for the production of one or more focal points which are also as large as possible, that focusing on the subsequent lens(es) positioned and with the exact sizes or next to this focal point(s), will produce one or more subsequent focal points, where will have other superimposed lens(es) with the sizes and position being exact or near to the focal point produced by preceding lens(es); and so on, until it is obtained by the last lens(es) (65) of the set of subsequent superposition, in a preferred constructive option, through the last concave outer rear face, one or more parallel or convergent beams (60) of maximum power possible or suitable for the purpose for which it is intended.

In a constructive option, the concentrator has one or more of the above first receiving lenses, and one or more subsequent lens(es) superimposed and sized by the focal point produced by the first lens(es). This superposition of the first lens on the subsequent lens(es) will produce a focal point or more than one, wherein a further lens or more of a subsequent lens will be positioned, which in turn produce other focal point(s), and so on, which allows high radiation rates to be imputed in a medium, to collect or read information from this medium, to transport them, to replicate them or not through the quantity of subsequent lenses, to assemble them or not through the quantity of subsequent lenses, projecting the original information or adding more information in a medium sufficient for its materialization or reading.

Each lens(es) section is composed of one or more adjacent lenses which are positioned at the focal point or focal points of the preceding lens(es) section.

Each lens section, in the case of containing two or more lenses, divides the area of the adjacent point or focal points produced by the preceding lens(es) section. Or in the case of only one lens, it has its size and shape of the perimeter of this lens defined by the preceding focal point or preceding adjacent focal points.

Each lens section (50) is formed by two or more adjacent lenses (51) superimposed on the focal point of the preceding lens, dividing the area and the radiation of the focal point by the number of lenses therein superimposed.

Each section of adjacent (51) lenses (50) superimposed on the focal point of the preceding lens(es) concentrates its focal point on the posterior subsequent lens or posterior subsequent lens section (50) of the set.

In order to alter, increase or decrease, add or subtract radiation or information to the produced beam, the lens(es)/shield(s), in a constructive option, are charged with energy electromagnetic field(s) and/or information. The concentrator may comprise shield(s) (45) which absorbs and/or transmits information to the electromagnetic beam (55).

1-16. (canceled)

17. A solar and electromagnetic energy concentrator (1) characterized by comprising two or more lenses (50) and/or two or more adjacent lenses sections (51) subsequent with different perimeters, in which the lens (50) or adjacent lenses section (51) perimeter determinate by the focal points perimeter produced by the preceding lens (50) or preceding adjacent lenses section (51), wherein another lens (50) or adjacent lenses section (51) is superimposed; and so on, until a parallel or convergent beam is produced concentrated by the last lens of the set and for presenting:
directing and/or magnifying lenses (50) and/or adjacent lenses section (51) subsequent of the first lens (50) or subsequent of the first adjacent lenses section (51), positioned on the preceding lens focal point (50) or positioned on the preceding adjacent lenses section (51) focal points, in which this lenses made by toughened, ceramic, quartz glass, quartz crystal lenses, silicon lenses or different physicochemical compositions necessary to refract the radiation for which is intended and support the conditions caused by the radiation concentration.

18. The solar and electromagnetic energy concentrator (1), according to claim 17, characterized by comprising magnifying and/or directing flat concave, convex-concave, flat convex, biconcave and/or biconvex lenses (50).

19. The solar and electromagnetic energy concentrator (1), according to claim 17, characterized by comprising magnifying and/or directing biconvex lenses (50) or biconvex lenses section (51).

20. The solar and electromagnetic energy concentrator (1), according to claim 17, characterized by presenting lenses (50) or magnifying and/or directing adjacent lenses section (51), subsequent to the first, with equivalent perimeter to the focal point perimeter produced by preceding lens (50) or the focal point perimeter produced by preceding adjacent lenses section (51).

21. The solar and electromagnetic energy concentrator (1), according to claim 17, characterized by presenting the last magnifying and/or directing lenses (50) made by quartz glass or by quartz crystal for supporting the high temperatures of intended radiation.

22. The solar and electromagnetic energy concentrator (1), according to claim 17, characterized by comprising shield made by silicon with the function of magnifying and/or directing lenses (50) for refracting and concentrating gamma radiation.

23. The solar and electromagnetic energy concentrator (1), according to claim 17, characterized by presenting superimposed lenses (50) on the focal point or focal points produced by the preceding lens (50) or preceding adjacent lenses section (51).

24. The solar and electromagnetic energy concentrator (1), according to claim 17, characterized by comprising superposition of two or more adjacent biconvex magnifying and/or directing adjacent lenses (50) positioned side by side forming a lenses section (51).

25. The solar and electromagnetic energy concentrator (1), according to claim 17, characterized by comprising two or more adjacent lenses sections (51) superimposed on the focal point produced by the preceding lens (50) or preceding adjacent lenses section (51).

26. The solar and electromagnetic energy concentrator (1), according to claim 17, characterized by comprising shield(s) (45) which absorb and/or transmit information to the electromagnetic beam (55).

27. The solar and electromagnetic energy concentrator (1), according to claim 17, characterized by comprising the last lens (65) of the set with concave posterior face for directing one or more parallel beams (60) on the set output.
